(19) United States
(12) Patent Application Publication
(10) Pub. No.: US 2020/0293989 A1
(43) Pub. Date: Sep. 17, 2020

(54) INFORMATION PROCESSING SYSTEM, INFORMATION PROCESSING METHOD, COMMODITY GENERATING APPARATUS, COMMODITY GENERATION METHOD, AND COMPUTER-READABLE STORAGE MEDIUM

(71) Applicant: SoftBank Group Corp., Tokyo (JP)

(72) Inventor: Masayoshi Son, Tokyo (JP)

(21) Appl. No.: 16/596,762

(22) Filed: Oct. 9, 2019

(30) Foreign Application Priority Data
Mar. 15, 2019 (JP) 2019-048399

(51) Int. Cl. G06Q 10/08; H04W 4/029; H04W 4/12

(52) U.S. Cl. CPC G06Q 10/0835; H04W 88/02; H04W 4/12; H04W 4/029

(57) ABSTRACT

An information processing system is provided, the information processing system including: a user-related information acquiring unit that acquires user-related information sent by a mobile communication terminal of a user and including positional information of the mobile communication terminal; an arrival time predicting unit that predicts an arrival time at which the user arrives at a retail store, based on the user-related information; a generation time indication acquiring unit that acquires an indication of generation time during which a commodity that the user wishes to receive is generated at the retail store; and a start time deciding unit that decides a generation start time for the commodity based on the arrival time and the generation time.

The contents of the following Japanese patent application are incorporated herein by reference: 2019-048399 filed in JP on Mar. 15, 2019

### BACKGROUND

### 1. Technical Field

The present invention relates to an information processing system, an information processing method, a commodity generating apparatus, a commodity generation method, and a computer-readable storage medium.

### 2. Related Art

There are known systems to handle orders for commodities to go (see Patent Literature 1, for example).

### PRIOR ART LITERATURE

### Patent Literature

[Patent Literature 1] Japanese Patent Application Publication No. 2018-106625

### SUMMARY

For example, if an attempt is made to realize a service of receiving a notification of a to-be-purchased commodity and a scheduled arrival time from a mobile communication terminal of a user, and preparing the commodity in time by the scheduled arrival time on a retail store's end, and if, in such a case, the user was late, arriving at the retail store after the scheduled arrival time, problems occur in some cases, such as deterioration of the commodity quality, occurrence of waiting time due to recreation of the commodity, or an inadvertent adverse influence on the commodity disposal rate since the commodity has to be inevitably disposed of. It is desirable to provide a technology that suppresses the occurrence of such problems.

### BRIEF DESCRIPTION OF THE DRAWINGS

FIG. 1 schematically illustrates an exemplary information processing system 10.

FIG. 2 is an explanatory figure for explaining contents of processing to be performed by the information processing system 10.

FIG. 3 schematically illustrates an exemplary configuration of the information processing system 10.

FIG. 4 schematically illustrates another exemplary configuration of the information processing system 10.

FIG. 5 schematically illustrates an exemplary flow of processing to be performed by the information processing system 10.

FIG. 6 is an explanatory figure for explaining changes in commodity generation situation.

FIG. 7 is an explanatory figure for explaining changes in commodity generation situation.

FIG. 8 schematically illustrates an exemplary functional configuration of a managing apparatus 100.

FIG. 9 schematically illustrates an exemplary functional configuration of a commodity generating apparatus 200.

FIG. 10 schematically illustrates an exemplary hardware configuration of a computer 1200 to function as the managing apparatus 100 or the commodity generating apparatus 200.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

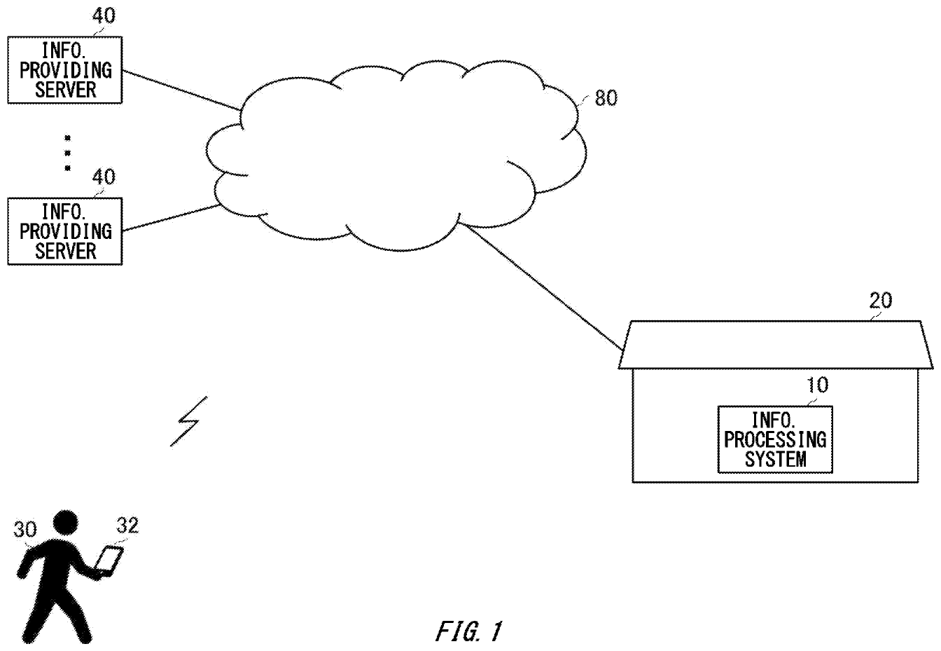

FIG. 1 schematically illustrates an exemplary information processing system 10. The information processing system 10 according to the present embodiment executes information processing targeted at a retail store 20. The retail store 20 may be a pre-order retail store that receives an order from a mobile communication terminal 32 of a user 30, generates an ordered commodity, and hands over the commodity to the visiting user.

The information processing system 10 may communicate with the mobile communication terminal 32 via a network 80. The network 80 may include a cellular communication network and the Internet. The cellular communication network may conform to any of the 3G (3rd Generation) communication standard, LTE (Long Term Evolution) communication standard, 5G (5th Generation) communication standard, or communication standards of and following the 6G (6th Generation) communication standard. The mobile communication terminal 32 may access the cellular communication network via a wireless base station, or may access the cellular communication network via a WiFi (registered trademark) network. The mobile communication terminal 32 may be a mobile phone such as a smartphone, a tablet terminal, or the like.

Commodities that the retail store 20 handles are coffee, fast foods, and the like, for example. Commodities that the retail store 20 handles are not limited to them, but may be any commodity. The present embodiment explained illustrates mainly an example in which the retail store 20 is a coffee shop that handles commodities to go.

Coffee shops and the like are often crowded with many customers, and for example if the user 30 is to order a commodity after arriving at the retail store 20, he/she has to wait for a long time until he/she can place an order, and has to wait for a long time again until the commodity is generated after the order is placed, thus inevitably resulting in a long waiting time. In view of this, it is conceivable, for example, to provide a service of receiving a notification of a to-be-purchased commodity and a scheduled arrival time from the mobile communication terminal 32 of the user 30, and generating the commodity in time by the scheduled arrival time on the retail store 20's end. Thereby, a waiting time of the user 30 at the retail store 20 can be reduced significantly.

However, if such a service is provided, and if, in such a case, the user 30 was late, arriving at the retail store 20 after the scheduled arrival time, problems occur in some cases, such as deterioration of the commodity quality, occurrence of waiting time due to recreation of the commodity, or an inadvertent adverse influence on the commodity disposal rate since the commodity has to be inevitably disposed of.

The information processing system 10 according to the present embodiment predicts an arrival time at which the user 30 arrives at the retail store 20, and also acquires an indication of generation time required for generating a commodity that the user 30 wants to purchase, and decides a generation start time for the commodity based on the arrival time and the generation time. For example, the information processing system 10 decides the generation start time such that generation of the commodity is completed by the arrival time.

The information processing system 10 may predict the time of arrival of the user 30 at the retail store 20 based on user-related information related to the user 30, and received from the mobile communication terminal 32. The user-related information includes positional information indicating the position of the mobile communication terminal 32. The user-related information may further include any information related to the user 30. For example the user-related information includes travel speed information indicating the travel speed of the user 30. In addition, for example, the user-related information includes the gender, age and the like of the user 30.

The information processing system 10 may predict the arrival time based further on public data provided by one or more information providing server 40. For example, the public data includes traffic information, weather information, and the like of a travel route from the position of the mobile communication terminal 32 to the retail store 20. The traffic information may include the number of signals, congestion situation, and the like in a travel route from the position of the mobile communication terminal 32 to the retail store 20. The information processing system 10 may communicate with an information providing server 40 via the network 80.

The retail store 20 may start generation of the commodity according to the generation start time decided by the information processing system 10. Then, the retail store 20 may hand over the generated commodity to the user 30 who arrived at the retail store 20.

By the information processing system 10 using various types of information to predict the time of arrival of the user 30 at the retail store 20 in this manner, it is possible to prepare a commodity in time by an actual arrival time of the user 30 even if, as a result, the user 30 was late, inadvertently arriving at the retail store 20 after the scheduled arrival time designated by the user 30.

Although FIG. 1 illustrates an example in which the information processing system 10 is installed in the retail store 20, this is not the sole example. The information processing system 10 can be arranged at any location outside the retail store 20 where it can communicate with an apparatus in the retail store 20 via the network 80.

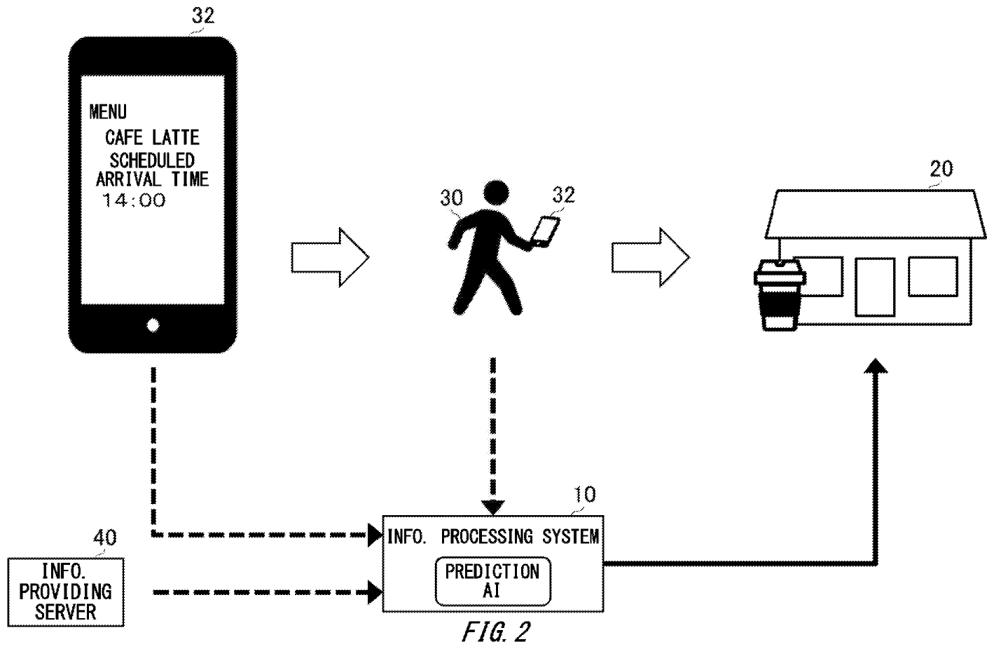

FIG. 2 is an explanatory figure for explaining contents of processing to be performed by the information processing system 10. In the example explained here, the information processing system 10 uses prediction AI (Artificial Intelligence) to predict an arrival time at which the user 30 arrives at the retail store 20.

The prediction AI uses at least the user-related information to predict a time of arrival of the user 30 at the retail store 20. The prediction AI may further use the public data to predict the arrival time. The prediction AI is generated through machine learning performed by collecting a large amount of user-related information, public data, and travel time that are generated when users actually travel from various locations to the retail store 20, for example.

The information processing system 10 may decide the generation start time for the commodity based on the arrival time predicted by using the prediction AI, and commodity generation time. Note that the prediction AI may be configured to output an indication of a generation start time for a commodity. The information processing system 10 may notify a store clerk at the retail store 20 of a generation start time decided based on the arrival time predicted by using the prediction AI and the commodity generation time, or the generation start time output by the prediction AI, and/or may send either one of the generation start times to a commodity generating apparatus such as an automatic cooker installed in the retail store 20.

The mobile communication terminal 32 may send the user-related information to the information processing system 10 repetitively while the user 30 is travelling. The user-related information repetitively sent by the mobile communication terminal 32 includes the positional information of the mobile communication terminal 32. In addition, the user-related information may include information indicating the travel speed of the mobile communication terminal 32.

Based on the repetitively received user-related information, the information processing system 10 repetitively predicts the arrival time at which the user 30 arrives at the retail store 20, and alters the generation start time for the commodity as necessary. For example, if the arrival time is delayed, the information processing system 10 delays the generation start time accordingly. If the information processing system 10 alters the generation start time, the information processing system 10 may notify a store clerk at the retail store 20 of the altered generation start time, and/or may send an indication of the altered generation start time to a commodity generating apparatus such as an automatic cooker installed in the retail store 20.

As mentioned above, it is possible to predict an arrival time at which the user 30 arrives at the retail store 20 highly precisely by predicting the arrival time by using prediction AI. In addition, it is possible to further improve the precision of prediction of an arrival time by repetitively predicting the arrival time by using the user-related information repetitively sent by the mobile communication terminal 32.

By deciding a generation start time for a commodity based on an arrival time predicted highly precisely in this manner, it is possible to reduce the occurrence of situations where generation of commodities is not completed yet when users 30 arrived at the retail store 20. In addition, if it is possible to reduce the occurrence of situations where the commodity quality deteriorates inevitably since commodities are inadvertently completed well before arrival of users 30 at the retail store 20 or the commodity disposal rate is adversely influenced inevitably since the commodities have to be inevitably disposed of.

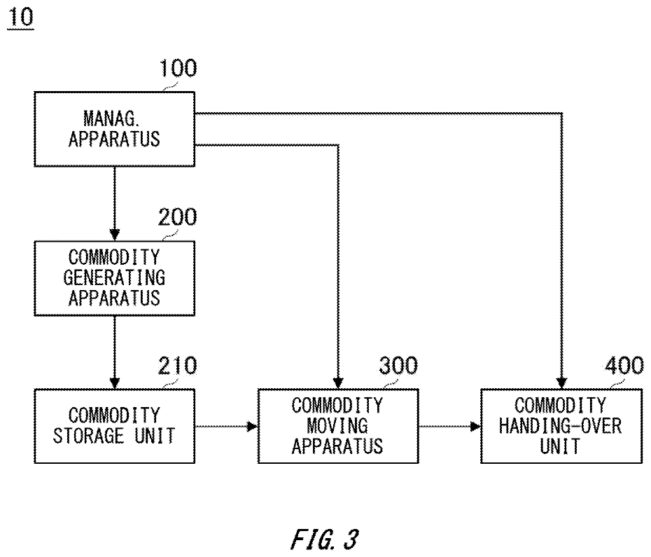

FIG. 3 schematically illustrates an exemplary configuration of the information processing system 10. FIG. 3 illustrates the information processing system 10 in an example where a commodity generating apparatus 200 to automatically generate commodities is installed at the retail store 20.

The information processing system 10 includes a managing apparatus 100. The information processing system 10 may further include the commodity generating apparatus 200. The information processing system 10 may further include a commodity storage unit 210. The information processing system 10 may further include a commodity moving apparatus 300. The information processing system 10 may further include a commodity handing-over unit 400.

The managing apparatus 100 receives a commodity purchase request by the user 30 from the mobile communication terminal 32. In addition, the managing apparatus 100 receives user-related information from the mobile communication terminal 32. The user-related information may be included in the purchase request. In addition, the managing apparatus 100 may receive, from an information providing server 40, public data about a travel route from the position indicated by the positional information of the mobile communication terminal 32 to the retail store 20.

The managing apparatus 100 may predict an arrival time at which the user 30 arrives at the retail store 20 based on the user-related information and the public data. In addition, the managing apparatus 100 may acquire an indication of generation time for the to-be-purchased commodity. Then, the managing apparatus 100 decides a generation start time for the commodity based on the arrival time and the generation time. The managing apparatus 100 may repetitively receive the user-related information from the mobile communication terminal 32 to repetitively predict the arrival time, and may alter the generation start time for the commodity as necessary. The managing apparatus 100 sends an indication of the generation start time for the commodity to the commodity generating apparatus 200.

The commodity generating apparatus 200 registers the generation start time for the commodity received from the managing apparatus 100. Then, when the generation start time for the commodity has come, generation of the commodity is started. The commodity generated by the commodity generating apparatus 200 may be arranged in the commodity storage unit 210.

According to an instruction from the managing apparatus 100, the commodity moving apparatus 300 moves the commodity arranged in the commodity storage unit 210 to the commodity handing-over unit 400. Based on a result of detection by an approach detecting unit that detects the user 30 approaching the retail store 20, the managing apparatus 100 moves the commodity to be handed over to the user 30 from the commodity storage unit 210 to the commodity handing-over unit 400. The commodity moving apparatus 300 moves the commodity from the commodity storage unit 210 to the commodity handing-over unit 400 by using a moving arm that moves commodities, a moving robot that moves commodities, a belt conveyer or the like, for example.

The approach detecting unit is arranged at an entrance of the retail store 20, for example, and detects the user 30 approaching the retail store 20 by a short-range wireless unit that executes short-range wireless communication with the mobile communication terminal 32. Upon arrival at the retail store 20, for example, the user 30 holds the mobile communication terminal 32 over the short-range wireless unit to thereby notify the managing apparatus 100 of his/her arrival at the retail store 20.

In addition, for example, the approach detecting unit detects the user 30 approaching the retail store 20 based on a WiFi router installed at the retail store 20, and the situation of communication with the mobile communication terminal 32 of the user 30. In addition, for example, the approach detecting unit may make a facial image of the user 30 included in the user-related information, and/or store, in advance, a facial image of the user 30 registered for the service, and thereby use the facial image of the user 30 acquired in advance and a captured image captured by a camera installed at the retail store 20 to detect the user 30 approaching the retail store 20. Other than these techniques, the approach detecting unit may use any technique to detect the user 30 approaching the retail store 20.

The commodity handing-over unit 400 includes a plurality of handing-over units each having an openable/closable door, for example. In each of the plurality of handing-over units, a commodity to be handed over to one of a plurality of users 30 is arranged.

If the approach detecting unit detected a user 30 approaching the retail store 20, for example, the managing apparatus 100 makes the commodity moving apparatus 300 arrange a commodity to be handed over to the user 30 in a vacant handing-over unit among the plurality of handing-over units, and notifies the mobile communication terminal 32 of the user 30 of handing-over unit identification information for identifying the handing-over unit in which the commodity is arranged. For example, the plurality of handing-over units are given numbers, and the managing apparatus 100 notifies such a number to the mobile communication terminal 32. The mobile communication terminal 32 outputs the notified number by display output or audio output. The user 30 checks the output number, and receives the commodity from the handing-over unit identified by the number.

The payment for the commodity can be executed at any timing in the flow explained above, for example at a timing when the mobile communication terminal 32 sent the purchase request to the managing apparatus 100, at a timing when the user 30 received the commodity from the handing-over unit, and so on.

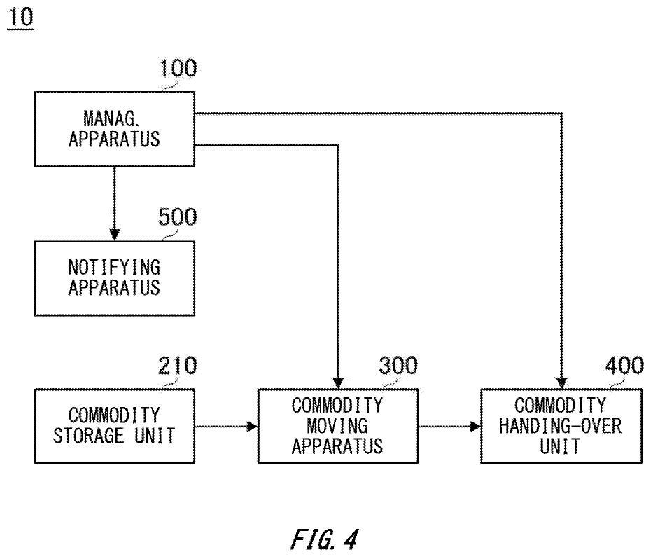

FIG. 4 schematically illustrates another exemplary configuration of the information processing system 10. FIG. 4 illustrates the information processing system 10 to be employed if generation of commodities is performed by a store clerk at the retail store 20. Here, differences from FIG. 3 are mainly explained.

In the information processing system 10 illustrated in FIG. 4, the managing apparatus 100 sends an indication of a generation start time for a commodity to a notifying apparatus 500. The notifying apparatus 500 notifies the generation start time for the commodity to a store clerk at the retail store 20. For example, the notifying apparatus 500 notifies the generation start time for the commodity to the store clerk by display output to a display arranged at the retail store 20. In addition, the notifying apparatus 500 notifies the generation start time for the commodity to the store clerk by audio output from a speaker arranged at the retail store 20, for example.

When the notified generation start time for the commodity has come, the store clerk starts generation of the commodity. The store clerk arranges the generated commodity in the commodity storage unit 210.

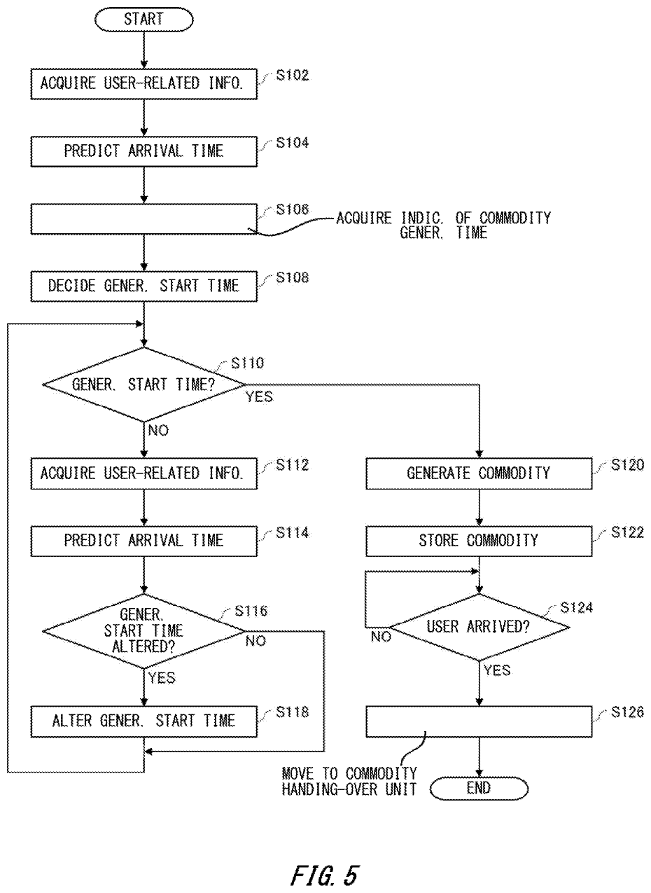

FIG. 5 schematically illustrates an exemplary flow of processing to be performed by the information processing system 10. Here, FIG. 5 schematically illustrates a flow of processing to be performed for one user 30 by the managing apparatus 100 if the user 30 sent a commodity purchase request to the managing apparatus 100 through the mobile communication terminal 32.

At Step (steps are abbreviated to S's in some cases) 102, the managing apparatus 100 acquires user-related information of the user 30. At S104, the managing apparatus 100 uses the user-related information acquired at S102 to predict a time of arrival of the user 30 at the retail store 20.

At S106, the managing apparatus 100 acquires an indication of commodity generation time required for generating the to-be-purchased commodity at the retail store 20. At S108, the managing apparatus 100 decides a generation start time for the commodity based on the arrival time predicted at S104, and the commodity generation time indicated by an indication acquired at S106. The managing apparatus 100 notifies the decided generation start time for the commodity to the commodity generating apparatus 200.

At S110, the managing apparatus 100 and commodity generating apparatus 200 determine whether or not the generation start time for the commodity decided at S108 has come. If not, the process proceeds to S112, and if so, the process proceeds to S120.

At S112, the managing apparatus 100 acquires the user-related information sent by the mobile communication terminal 32. At S114, the managing apparatus 100 uses the user-related information acquired at S112 to predict a time of arrival of the user 30 at the retail store 20.

At S116, the managing apparatus 100 determines whether to or not to alter the generation start time for the commodity based on the arrival time predicted at S114. The managing apparatus 100 determines to alter the generation start time for example if the difference between the arrival time predicted at S104 and the arrival time predicted at S114 is larger than a predetermined threshold. If it is determined to alter the generation start time, the process proceeds to S118. At S118, the managing apparatus 100 alters the generation start time based on the arrival time predicted at S114. The managing apparatus 100 notifies the altered generation start time to the commodity generating apparatus 200.

At S120, the commodity generating apparatus 200 starts generation of the commodity, and generates the commodity. At S122, the commodity generated by the commodity generating apparatus 200 is arranged in the commodity storage unit 210.

At S124, the managing apparatus 100 determines whether or not the user 30 has arrived at the retail store 20. If the approach detecting unit detects the user 30 approaching the retail store 20, the managing apparatus 100 may determine that the user 30 has arrived at the retail store 20. If it is determined that the user 30 has arrived, the process proceeds to S126.

At S126, the managing apparatus 100 makes the commodity moving apparatus 300 move the commodity arranged in the commodity storage unit 210 to the commodity handing-over unit 400. The commodity handing-over unit 400 may arrange the commodity in a vacant handing-over unit among a plurality of handing-over units of the commodity handing-over unit 400. The commodity arranged in the handing-over unit is received by the user 30 who arrived at the retail store 20.

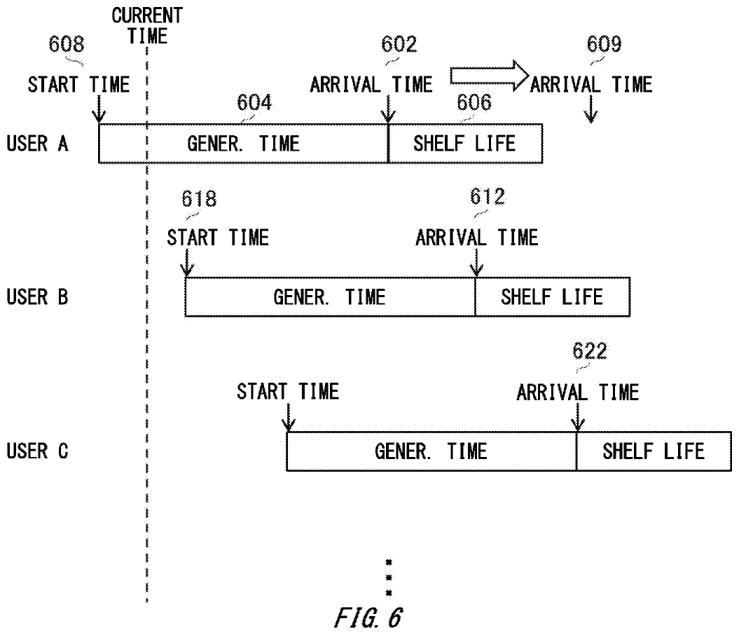

FIG. 6 is an explanatory figure for explaining changes in commodity generation situation. In an example explained with reference to FIG. 6, an arrival time 602 of a user A has changed to an arrival time 609 at a time point after a generation start time 608 for a commodity to be handed over to the user A and before a generation start time 618 for a commodity to be handed over to a user B. In the example mentioned here, the commodity to be handed over to the user A, the commodity to be handed over to the user B, and a commodity to be handed over to a user C are identical commodities.

A time which is commodity generation time 604 before the arrival time 602 is decided as the generation start time 608 such that generation of the commodity is completed at the arrival time 602 of the user A. A shelf life 606 indicates a time period that starts when generation of the commodity is completed and ends at a time after which the commodity is no longer allowed to be handed over to the user.

The shelf life 606 may be preset for each type of commodity. For example, if the commodity is hot coffee, a time period that ends at a time when the temperature of the commodity falls below a predetermined temperature is set as the shelf life 606. In addition, for example, if the commodity is hot coffee, a time period that ends at a time when the degree of oxidation of the commodity becomes higher than a predetermined degree is set as the shelf life 606.

Even if the arrival time 602 is delayed, the commodity can be handed over to the user A provided for example that the actual arrival time is still not beyond the shelf life 606, but the commodity cannot be handed over to the user A if the actual arrival time is beyond the shelf life 606.

The managing apparatus 100 according to the present embodiment checks the situation of preparation of commodities for users other than the user A in such a situation. Then, management is performed such that, if the arrival time 602 of the user A is delayed, the commodity started being generated for receipt by the user A is provided to a user among a plurality of users who wishes to receive a commodity identical to the commodity that the user A wishes to receive, whose generation start time for the commodity has not come, and whose arrival time is not beyond the shelf life 606 of the commodity started being generated for receipt by the user A, if such a user exists.

In the example illustrated in FIG. 6, since the commodity to be handed over to the user A and the commodity to be handed over to the user B are identical commodities, and an arrival time 612 of the user B is not beyond the shelf life 606 of the commodity for receipt by the user A, the commodity for receipt by the user A started being generated at the generation start time 608 can be provided to the user B. If it is determined to provide the commodity to the user B, the generation start time 618 for the commodity for receipt by the user B may be invalidated, and the generation start time for the commodity for receipt by the user A may be decided again based on the arrival time 609.

Note that although the commodity to be handed over to the user A and the commodity to be handed over to the user C are also identical commodities, an arrival time 622 of the user C is beyond the shelf life 606 of the commodity for receipt by the user A, and so the commodity for receipt by the user A started being generated at the generation start time 608 cannot be provided to the user C.

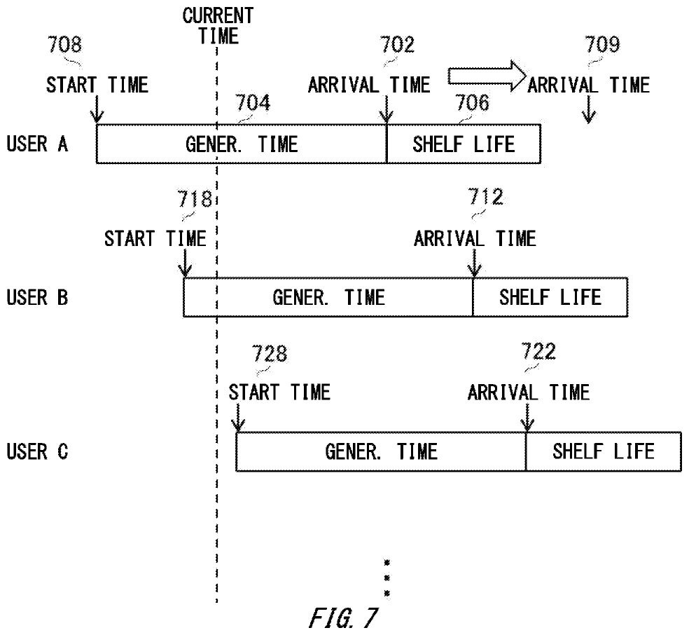

FIG. 7 is an explanatory figure for explaining changes in commodity generation situation. In an example explained with reference to FIG. 7, an arrival time 702 of the user A has changed to an arrival time 709 at a time point after the generation start time 608 for a commodity to be handed over to the user A and a generation start time 718 for a commodity to be handed over to the user B and before a generation start time 728 for a commodity to be handed over to the user C. In the example mentioned here, the commodity to be handed over to the user A, the commodity to be handed over to the user B, and the commodity to be handed over to a user C are identical commodities.

In the situation illustrated in FIG. 7, the managing apparatus 100 performs management provide the commodity started being generated for receipt by the user A to a user among a plurality of users who wishes to receive a commodity identical to the commodity that the user A wishes to receive, whose generation start time for the commodity has not come, and whose arrival time is not beyond the shelf life 606 of the commodity started being generated for receipt by the user A, if such a user exists.

In the example illustrated in FIG. 7, the current time is after the generation start time 718 for the commodity for receipt by the user B. On the other hand, since the generation start time 728 for the commodity for receipt by the user C has not come, the commodity to be handed over to the user C, and the commodity to be handed over to the user A are identical commodities, and an arrival time 722 of the user C is not beyond the shelf life 706 of the commodity for receipt by the user A, the managing apparatus 100 can provide the user C with the commodity for receipt by the user A started being generated at the generation start time 708. If it is determined to provide the commodity to the user C, the generation start time 728 for the commodity for receipt by the user C may be invalidated, and the generation start time for the commodity for receipt by the user A may be decided again based on the arrival time 709.

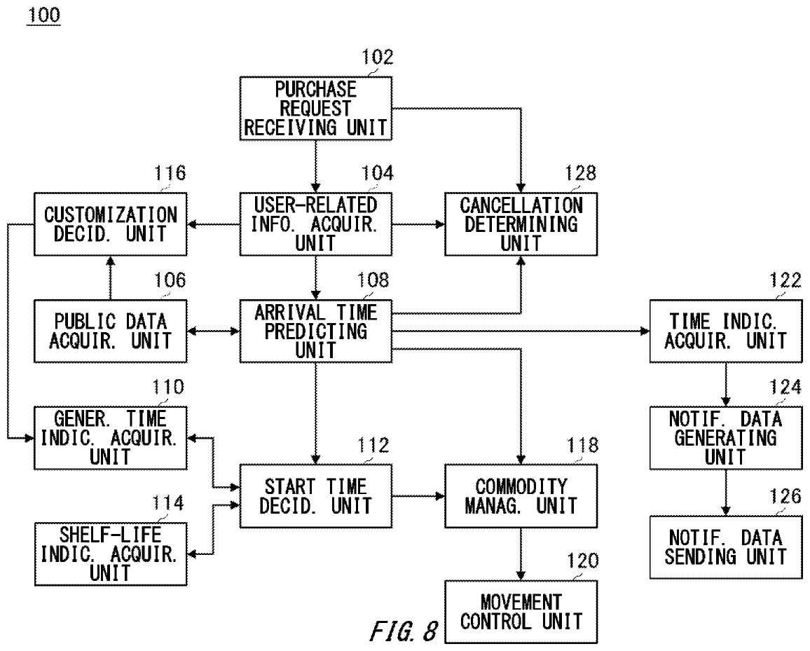

FIG. 8 schematically illustrates an exemplary functional configuration of the managing apparatus 100. The managing apparatus 100 includes a purchase request receiving unit 102, a user-related information acquiring unit 104, a public data acquiring unit 106, an arrival time predicting unit 108, a generation time indication acquiring unit 110, a start time deciding unit 112, a shelf-life indication acquiring unit 114, a customization deciding unit 116, a commodity managing unit 118, a movement control unit 120, a time indication acquiring unit 122, a notification data generating unit 124, a notification data sending unit 126, and a cancellation determining unit 128. Note that the managing apparatus 100 is not necessarily required to include all of these configurations.

The purchase request receiving unit 102 receives a commodity purchase request by the user 30. The purchase request receiving unit 102 may receive the purchase request sent by the mobile communication terminal 32. The purchase request includes information about a commodity that the user 30 wishes to receive. In addition, the purchase request may include a scheduled time of arrival at the retail store 20 designated by the user 30. In addition, the purchase request may include user-related information.

The user-related information acquiring unit 104 acquires the user-related information sent by the mobile communication terminal 32 of the user 30. If the purchase request received by the purchase request receiving unit 102 includes user-related information, the user-related information acquiring unit 104 may acquire the user-related information. If the purchase request does not include user-related information, the user-related information acquiring unit 104 may receive user-related information from the mobile communication terminal 32.

The public data acquiring unit 106 acquires public data of a travel route from the position of the mobile communication terminal 32 to the retail store 20. The public data acquiring unit 106 may receive the public data from an information providing server 40. For example, the public data acquiring unit 106 sends, to the information providing server 40, information indicating a travel route from the position of the mobile communication terminal 32 to the retail store 20, and receives, from the information providing server 40, the public data of the travel route.

The arrival time predicting unit 108 predicts am arrival time at which the user 30 arrives at the retail store 20 based on the user-related information acquired by the user-related information acquiring unit 104. The arrival time predicting unit 108 may predict the time of arrival of the user 30 at the retail store 20 based on the user-related information acquired by the user-related information acquiring unit 104, and the public data acquired by the public data acquiring unit 106. For example, the arrival time predicting unit 108 may use arrival AI to predict the arrival time.

The generation time indication acquiring unit 110 acquires an indication of generation time during which a commodity that the user 30 wishes to receive is generated at the retail store 20. The generation time may be time required for generating a commodity at the retail store 20. The generation time indication acquiring unit 110 acquires an indication of the generation time corresponding to a commodity by referring to generation time correspondence data in which generation time is associated with each commodity, for example.

The start time deciding unit 112 decides a generation start time for a commodity. The start time deciding unit 112 decides the generation start time for the commodity based on the arrival time predicted by the arrival time predicting unit 108, and the generation time indicated by an indication acquired by the generation time indication acquiring unit 110.

For example, the start time deciding unit 112 decides, as the generation start time, a time which is the generation time indicated by an indication acquired by the generation time indication acquiring unit 110 before the arrival time predicted by the arrival time predicting unit 108. The start time deciding unit 112 may decide, as the generation start time, a time which is a predetermined length of time before a time which is the generation time before the arrival time. The predetermined length of time is, for example, a length of time required after generation of the commodity is completed until the commodity is made ready for receipt by the user 30.

The shelf-life indication acquiring unit 114 acquires an indication of a shelf life of a commodity that the user 30 wishes to receive. The shelf-life indication acquiring unit 114 acquires an indication of the shelf life corresponding to a commodity by referring to shelf-life correspondence data in which a shelf life is associated with each commodity, for example.

The start time deciding unit 112 may decide the generation start time for the commodity based further on the shelf life indicated by an indication acquired by the shelf-life indication acquiring unit 114. For example, the start time deciding unit 112 decides, as the start time, a time which is a predetermined time period before the arrival time, the predetermined time period being the sum of the generation time and at least part of the shelf life.

The start time deciding unit 112 may decide the generation start time based further on characteristics information indicating characteristics of the user 30. The characteristics information may include tastes, personality, and the like of the user 30. In addition, the characteristics information may include the nature that the user 30 has about a commodity. If the commodity is a hot drink, the nature about the commodity indicates, for example, whether the user 30 wishes to have a just-made drink as the commodity to receive, whether the user 30 does not wish to have a just-made drink for reasons such as having a tongue which is too sensitive to heat, or other natures. For example, the characteristics information is included in the user-related information.

For example, if the user 30 wishes to have a just-made commodity as the commodity to receive, the start time deciding unit 112 decides, as a generation start time, a time which is generation time or a length of time shorter than the generation time before the arrival time. In addition, for example, if the user 30 does not wish to have a just-made commodity as the commodity to receive, the start time deciding unit 112 decides, as the generation start time, a time which is before a time which is generation time before the arrival time.

The customization deciding unit 116 decides customization of a commodity to be recommended to the user 30 based on the user-related information. For example, if the user 30 wishes to receive hot coffee, the customization deciding unit 116 decides a recommended type of bean, duration of roasting, amount of sugar, amount of milk, and the like based on the user-related information. In addition, the customization deciding unit 116 may decide a recommend side dish based on the user-related information. The customization deciding unit 116 may decide customization of a commodity to be recommended to the user 30 based further on the public data.

The customization deciding unit 116 decides customization of a commodity to be recommended to the user 30 based on the position, taste, personality, purchase behavior, weather information and the like of the user 30, for example. In addition, the customization deciding unit 116 may decide customization of a commodity to be recommended to the user 30 based further on physical data such as the body temperature, blood pressure, heart rate, or pulse of the user 30. The physical data of the user 30 is obtained through measurement by a wearable device worn by the user 30, for example, and sent to the managing apparatus 100 via the mobile communication terminal 32.

The customization deciding unit 116 may send an indication of decided customization to the mobile communication terminal 32 to recommend it to the user 30. If accepted by the user 30, the customization deciding unit 116 decides to customize the commodity. If the customization deciding unit 116 decided to customize the commodity, the generation time indication acquiring unit 110 acquires an indication of generation time required for generating the commodity if it is customized in a decided manner. The commodity generation time that is required if each type of customization is performed may be pre-registered.

The user-related information acquiring unit 104 may acquire the user-related information repetitively sent by the mobile communication terminal 32. The arrival time predicting unit 108 may repetitively predict the arrival time at which the user 30 arrives at the retail store 20 based on the repetitively sent user-related information. The start time deciding unit 112 may alter the generation start time as necessary based on the repetitively predicted arrival time.

The commodity managing unit 118 manages a generated commodity that was started being generated at a generation start time decided by the start time deciding unit 112. For example, management is performed such that a commodity that a first user among a plurality of users 30 wishes to receive and that has been started being generated for receipt by the first user is provided to a second user among the plurality of users who wishes to receive an identical commodity to the commodity that the first user wishes to receive if the start time deciding unit 112 decides the generation start time for each of the plurality of users 30, and the arrival time of the first user is delayed after the generation of the commodity has been started after the generation start time for the first user has come. The customization deciding unit 116 may perform management provide the commodity that the first user wishes to receive and that has been started being generated for receipt by the first user to the second user among the plurality of users who wishes to receive the identical commodity to the commodity that the first user wishes to receive, and whose arrival time is not beyond the shelf life of the commodity that has been started being generated for receipt by the first user.

Thereby, if the first user does not arrive at the retail store 20 not beyond the shelf life of the commodity that was started being generated for receipt by the first user, and the commodity cannot be handed over to the first user, the commodity does not have to be disposed of, by providing the commodity instead to the second user. Note that, for example, among a plurality of users who satisfy conditions, a user who arrives at the retail store 20 at a time closer to the start time of the shelf life of a commodity that was started being generated for receipt by the first user may be determined as the second user. Thereby, the length of time that elapses after generation of the commodity is completed until the commodity is handed over can be made as short as possible.

The movement control unit 120 moves, to the commodity handing-over unit 400, a commodity that was started being generated at a generation start time decided by the start time deciding unit 112, and is stored in the commodity storage unit 210 after the generation is completed. The movement control unit 120 may cause the commodity moving apparatus 300 to move a commodity stored in the commodity storage unit 210 to a handing-over unit of the commodity handing-over unit 400. Based for example on a result of detection by an approach detecting unit that detects the user 30 approaching the retail store 20, the movement control unit 120 moves a commodity from the commodity storage unit 210 to a handing-over unit.

If the retail store 20 cannot generate a commodity that a user 30 wishes to receive by an arrival time predicted by the arrival time predicting unit 108, the time indication acquiring unit 122 acquires an indication of a time by which the retail store 20 can generate the commodity. The time indication acquiring unit 122 acquires the indication of the time from the commodity generating apparatus 200, for example. In addition, the time indication acquiring unit 122 acquires the indication of the time input by a store clerk at the retail store 20, for example.

The notification data generating unit 124 generates notification data for the user 30 based on the time indicated by the indication acquired by the time indication acquiring unit 122. The notification data generating unit 124 generates notification data for notifying the time indicated by the indication acquired by the time indication acquiring unit 122, for example.

In addition, based for example on the time indicated by the indication acquired by the time indication acquiring unit 122, and the commodity that the user 30 wishes to receive, the notification data generating unit 124 finds a commodity that can be generated by an arrival time predicted by the arrival time predicting unit 108, and generates notification data for notifying the found commodity. For example, the notification data generating unit 124 finds a commodity which is among commodities similar to the commodity that the user 30 wishes to receive, and can be generated by the arrival time predicted by the arrival time predicting unit 108. Whether or not commodities are similar to each other may be pre-registered.

If a purchase request received by the purchase request receiving unit 102 includes a scheduled arrival time, the cancellation determining unit 128 determines whether to or not to cancel the purchase request based on positional information included in the user-related information acquired by the user-related information acquiring unit 104, and the scheduled arrival time. For example, if the difference between an estimated arrival time at which the user 30 arrives at the retail store 20 if the user 30 traveled from the position of the user 30 to the retail store 20, and the scheduled arrival time is longer than a predetermined threshold, the cancellation determining unit 128 determines to cancel the purchase request.

The purchase request receiving unit 102 may receive a request to purchase a subscription of a commodity including the scheduled time of arrival at the retail store 20. The cancellation determining unit 128 may determine whether to or not to cancel the purchase request based on the scheduled arrival time, and the positional information of the mobile communication terminal 32 sent by the mobile communication terminal 32 before the scheduled arrival time.

For example, in the following example explained, the mobile communication terminal 32 of the user 30 sent, to the managing apparatus 100, a request to purchase a subscription for hot coffee at 9 a.m. weekdays. Before 9 a.m., which is the scheduled arrival time, the mobile communication terminal 32 repetitively sends the user-related information including the positional information of the mobile communication terminal 32 to the managing apparatus 100. The arrival time predicting unit 108 repetitively estimates the arrival time at which the user 30 arrives at the retail store 20 from the position of the mobile communication terminal 32 based on the repetitively sent user-related information. The cancellation determining unit 128 compares the repetitively estimated arrival time, and 9 o'clock, which is the scheduled arrival time, and for example, if the difference between the estimated arrival time and the scheduled arrival time is equal to or longer than a predetermined length of time such as one hour, the cancellation determining unit 128 determines to cancel the commodity.

Thereby, the user 30 can receive just-made or almost just-made hot coffee at 9 a.m. every morning at the retail store 20 in normal occasions, and can automatically cancel hot coffee without having to inform the retail store 20 of cancellation if the user 30 cannot go to the retail store 20 because of a business trip, vacation, or the like, thereby improving the convenience for the user 30.

If the cancellation determining unit 128 determined to cancel the purchase request, the cancellation determining unit 128 may send, to the mobile communication terminal 32, recommendation information for recommending a retail store based on the positional information of the mobile communication terminal 32. For example, the cancellation determining unit 128 sends, to the mobile communication terminal 32, recommendation information for recommending an affiliated retail store closest to the position indicated by the positional information of the mobile communication terminal 32. Thereby, for example, if the user 30 who has subscribed to a commodity is at a different location for a business trip, the user 30 may be informed of the location of an affiliated store so that it is made possible for the user 30 to obtain a commodity as usual, even when the user 30 is on a business trip.

Although in the embodiment explained above, the generation start time for a commodity is decided by the managing apparatus 100, this is not the sole example. The commodity generating apparatus 200 may decide the generation start time for a commodity. For example, the commodity generating apparatus 200 receives, from the managing apparatus 100, an indication of an arrival time at which the user 30 arrives at the retail store 20 predicted by the managing apparatus 100, acquires an indication of generation time for a commodity that the user 30 wishes to receive, and decides a generation start time for the commodity based on the arrival time and the generation time. For example, the commodity generating apparatus 200 stores in advance generation time correspondence data in which generation time is associated with each commodity, and acquires an indication of the generation time corresponding to a commodity by referring to the generation time correspondence data. In addition, the commodity generating apparatus 200 may receive an indication of commodity generation time from the managing apparatus 100.

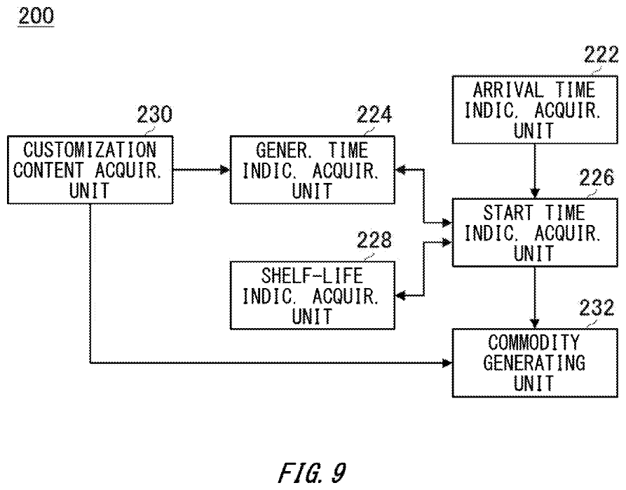

FIG. 9 schematically illustrates an exemplary functional configuration of the commodity generating apparatus 200. The commodity generating apparatus 200 includes an arrival time indication acquiring unit 222, a generation time indication acquiring unit 224, a start time indication acquiring unit 226, a shelf-life indication acquiring unit 228, a customization content acquiring unit 230, and a commodity generating unit 232. Note that the commodity generating apparatus 200 is not necessarily required to include all of these configurations.

The arrival time indication acquiring unit 222 acquires an indication of an arrival time at which the user 30 arrives at the retail store 20, the arrival time being predicted based on user-related information including positional information of the mobile communication terminal 32 sent by the mobile communication terminal 32 of the user 30. The arrival time indication acquiring unit 222 may receive, from the managing apparatus 100, an indication of an arrival time that the managing apparatus 100 predicted based on the user-related information.

The generation time indication acquiring unit 224 acquires an indication of generation time during which a commodity that the user 30 wishes to receive is generated at the retail store 20. For example, the generation time indication acquiring unit 224 stores in advance generation time correspondence data in which generation time is associated with each commodity, and acquires an indication of the generation time corresponding to a commodity by referring to the generation time correspondence data. The generation time indication acquiring unit 224 may receive an indication of commodity generation time from the managing apparatus 100.

The start time indication acquiring unit 226 acquires an indication of a generation start time for a commodity. The start time indication acquiring unit 226 may decide a generation start time for a commodity based on an arrival time indicated by an indication acquired by the arrival time indication acquiring unit 222, and commodity generation time indicated by an indication acquired by the generation time indication acquiring unit 224. For example, the start time indication acquiring unit 226 decides, as the generation start time, a time which is the generation time indicated by an indication acquired by the generation time indication acquiring unit 224 before the arrival time indicated by an indication acquired by the arrival time indication acquiring unit 222. The start time indication acquiring unit 226 may decide, as the generation start time, a time which is a predetermined length of time before a time which is the generation time before the arrival time. The predetermined length of time is, for example, a length of time required after generation of the commodity is completed until the commodity is made ready for receipt by the user 30.

The shelf-life indication acquiring unit 228 acquires an indication of a shelf life of a commodity that the user 30 wishes to receive. For example, the shelf-life indication acquiring unit 228 stores in advance shelf-life correspondence data in which a shelf life is associated with each commodity, and acquires an indication of the shelf life corresponding to the commodity by referring to the shelf-life correspondence data. The shelf-life indication acquiring unit 228 may receive an indication of a shelf life of a commodity from the managing apparatus 100.

The start time indication acquiring unit 226 may decide the generation start time for the commodity based further on the shelf life indicated by an indication acquired by the shelf-life indication acquiring unit 228. For example, the start time indication acquiring unit 226 decides, as the start time, a time which is a predetermined time period before the arrival time, the predetermined time period being the sum of the generation time and at least part of the shelf life. Similar to the start time deciding unit 112, the start time indication acquiring unit 226 may decide the generation start time based further on characteristics information indicating characteristics of the user 30.

The customization content acquiring unit 230 acquires contents of customization to be performed for a commodity that the user 30 wishes to receive. For example, the customization content acquiring unit 230 receives contents of customization decided by the customization deciding unit 116 from the managing apparatus 100. The generation time indication acquiring unit 224 may acquire an indication of generation time for a commodity that the user 30 wishes to receive that is required if the commodity is customized according to the contents of customization acquired by the customization content acquiring unit 230.

The commodity generating unit 232 starts generation of the commodity at a generation start time for the commodity indicated by the indication acquired by the start time indication acquiring unit 226, and generates the commodity. If the customization content acquiring unit 230 acquired contents of customization of a commodity, the commodity generating unit 232 may start generation of the commodity according to a generation start time for the commodity decided based on commodity generation time that is required if the customization is to be performed, and generate the customized commodity.

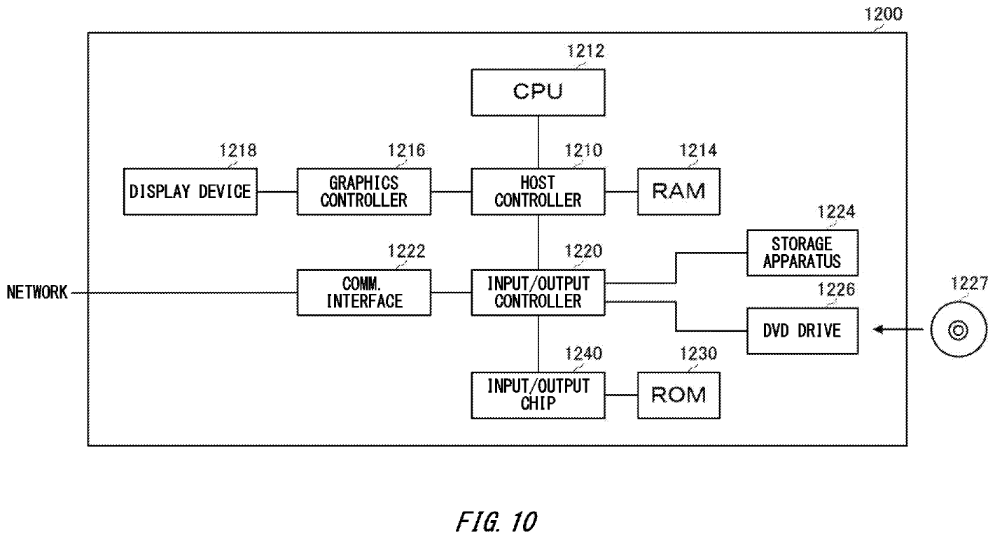

FIG. 10 schematically illustrates an exemplary hardware configuration of a computer 1200 to function as the managing apparatus 100 or the commodity generating apparatus 200. A program that is installed in the computer 1200 can cause the computer 1200 to function as or perform operations associated with apparatuses of the embodiments of the present invention or one or more sections thereof, and/or cause the computer 1200 to perform processes of the embodiments of the present invention or steps thereof. Such a program may be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage apparatus 1224, a DVD drive 1226 and an IC card drive, which are connected to the host controller 1210 via an input/output controller 1220. The DVD drive 1226 may be a DVD-ROM drive, a DVD-RAM drive, or the like. The storage apparatus 1224 may be a hard disk drive, a solid state drive, or the like. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on the display device 1218.

The communication interface 1222 communicates with other electronic devices via a network. The storage apparatus 1224 stores programs and data used by the CPU 1212 within the computer 1200. The DVD drive 1226 reads the programs or the data from the DVD-ROM 1227, and the like, and provides the storage apparatus 1224 with the programs or the data. The IC card drive reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 may also connect various input/output units via a USB port, a parallel port, a serial port, a keyboard port, a mouse port, and the like to the input/output controller 1220.

A program is provided by computer-readable storage media such as the DVD-ROM 1227 or the IC card. The program is read from the computer-readable storage media, installed into the storage apparatus 1224, RAM 1214, or ROM 1230, which are also examples of computer-readable storage media, and executed by the CPU 1212. The information processing described in these programs is read into the computer 1200, resulting in cooperation between a program and the above-mentioned various types of hardware resources. An apparatus or method may be constituted by realizing the operation or processing of information in accordance with the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the storage apparatus 1224, the DVD-ROM 1227, or the IC card, and transmits the read transmission data to a network or writes reception data received from a network to a reception buffering region or the like provided on the recording medium.

In addition, the CPU 1212 may cause all or a necessary portion of a file or a database to be read into the RAM 1214, the file or the database having been stored in an external recording medium such as the storage apparatus 1224, the DVD drive 1226 (DVD-ROM 1227), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer-readable storage media on or near the computer 1200. In addition, a recording medium such as a hard disk or a RAM provided in a server system connected to a dedicated communication network or the Internet can be used as the computer-readable storage media, thereby providing the program to the computer 1200 via the network.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable storage media, and/or processors supplied with computer-readable instructions stored on computer-readable storage media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable storage media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable storage media may include an electronic storage medium, a magnetic storage medium, an optical storage medium, an electromagnetic storage medium, a semiconductor storage medium, etc. More specific examples of computer-readable storage media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCE SYMBOLS

10: information processing system; 20: retail store; 30: user; 32: mobile communication terminal; 40: information providing server; 80: network; 100: managing apparatus; 102: purchase request receiving unit; 104: user-related information acquiring unit; 106: public data acquiring unit; 108: arrival time predicting unit; 110: generation time indication acquiring unit; 112: start time deciding unit; 114: shelf-life indication acquiring unit; 116: customization deciding unit; 118: commodity managing unit; 120: movement control unit; 122: time indication acquiring unit; 124: notification data generating unit; 126: notification data sending unit; 128: cancellation determining unit; 200: commodity generating apparatus; 210: commodity storage unit; 222: arrival time indication acquiring unit; 224: generation time indication acquiring unit; 226: start time indication acquiring unit; 228: shelf-life indication acquiring unit; 230: customization content acquiring unit; 232: commodity generating unit; 300: commodity moving apparatus; 400: commodity handing-over unit; 500: notifying apparatus; 602, 609, 612, 622: arrival time; 604: generation time; 606: shelf life; 608: start time; 702, 709, 722: arrival time; 706: shelf life; 708, 718, 728: start time; 1200: computer; 1210: host controller; 1212: CPU; 1214: RAM; 1216: graphics controller; 1218: display device; 1220: input/output controller; 1222: communication interface; 1224: storage apparatus; 1226: DVD drive; 1227: DVD-ROM; 1230: ROM; 1240: input/output chip

What is claimed is:

1. An information processing system comprising:
a user-related information acquiring unit that acquires user-related information sent by a mobile communication terminal of a user and including positional information of the mobile communication terminal;
an arrival time predicting unit that predicts an arrival time at which the user arrives at a retail store, based on the user-related information;
a generation time indication acquiring unit that acquires an indication of generation time during which a commodity that the user wishes to receive is generated at the retail store; and
a start time deciding unit that decides a generation start time for the commodity based on the arrival time and the generation time.

2. The information processing system according to claim 1, wherein
the user-related information acquiring unit acquires the user-related information repetitively sent by the mobile communication terminal,
the arrival time predicting unit repetitively predicts the arrival time at which the user arrives at the retail store, based on the repetitively sent user-related information, and
the start time deciding unit alters the generation start time based on the repetitively predicted arrival time.

3. The information processing system according to claim 1, comprising:
a shelf-life indication acquiring unit that acquires an indication of a shelf life indicating a time period that starts when generation of the commodity that the user wishes to receive is completed and ends at a time after which the commodity is no longer allowed to be handed over to the user, wherein
the start time deciding unit decides the generation start time based further on the shelf life.

4. The information processing system according to claim 1, wherein the start time deciding unit decides the generation start time based further on characteristics information indicating a characteristic of the user.

5. The information processing system according to claim 1, wherein
the arrival time predicting unit repetitively predicts the arrival time at which the user arrives at the retail store based on the user-related information repetitively sent by the mobile communication terminal, and
the information processing system comprises a commodity managing unit that performs management to provide a commodity that a first user among a plurality of users wishes to receive and that has been started being generated for receipt by the first user to a second user among the plurality of users who wishes to receive an identical commodity to the commodity that the first user wishes to receive if the start time deciding unit decides the generation start time for each of the plurality of users, and the arrival time of the first user is delayed after the generation of the commodity has been started after the generation start time for the first user has come.

6. The information processing system according to claim 5, wherein the commodity managing unit performs management to provide the commodity that the first user wishes to receive and that has been started being generated for receipt by the first user to the second user among the plurality of users who wishes to receive the identical commodity to the commodity that the first user wishes to receive, and the arrival time is not beyond a shelf life of the commodity that has been started being generated for receipt by the first user.

7. The information processing system according to claim 1, comprising a customization deciding unit that decides customization of a commodity recommended to the user based on the user-related information, wherein
the generation time indication acquiring unit acquires an indication of the generation time that is required if the customization decided by the customization deciding unit is to be performed for a commodity that the user wishes to receive.

8. The information processing system according to claim 1, comprising:
a time indication acquiring unit that acquires an indication of a time by which a commodity that the user wishes to receive can be generated if the commodity cannot be generated by the arrival time predicted by the arrival time predicting unit;
a notification data generating unit that generates notification data to the user based on the time; and
a notification data sending unit that sends the notification data to the mobile communication terminal of the user.

9. The information processing system according to claim 8, wherein the notification data generating unit generates the notification data to notify the time.

10. The information processing system according to claim 8, wherein, based on the time, and the commodity that the user wishes to receive, the notification data generating unit finds a commodity that can be generated by the arrival time predicted by the arrival time predicting unit, and generates the notification data to notify the found commodity.

11. The information processing system according to claim 1, comprising a purchase request receiving unit that receives the commodity purchase request by the user, wherein
if the purchase request receiving unit has received the purchase request, the arrival time predicting unit predicts the arrival time, and
if the purchase request receiving unit has received the purchase request, the generation time indication acquiring unit predicts the arrival time, and acquires an indication of the generation time.

12. The information processing system according to claim 11, wherein
the purchase request receiving unit receives the purchase request including a scheduled time of arrival at the retail store designated by the user, and
the information processing system comprises a cancellation determining unit that determines whether to or not to cancel the purchase request based on the positional information included in the user-related information sent by the mobile communication terminal, and the scheduled arrival time.

13. The information processing system according to claim 12, wherein
the purchase request receiving unit receives the purchase request for a subscription of the commodity including the scheduled arrival time, and
based on the scheduled arrival time, and positional information of the mobile communication terminal sent by the mobile communication terminal before the scheduled arrival time, the cancellation determining unit determines whether to or not to cancel the purchase request.

14. The information processing system according to claim 12, wherein if the cancellation determining unit has determined to cancel the purchase request, the cancellation determining unit sends retail store recommendation information for recommending a retail store to the mobile communication terminal based on the positional information.

15. The information processing system according to claim 1, comprising a movement control unit that moves the commodity from a commodity storage unit to a commodity handing-over unit based on a result of detection by an approach detecting unit that detects the user approaching the retail store, the commodity storage unit storing the commodity that has been started being generated at the generation start time and generation of which has been completed, the commodity handing-over unit handing over the commodity to the user.

16. A non-transitory computer-readable storage medium having stored thereon a program for making a computer function as:
a user-related information acquiring unit that acquires user-related information sent by a mobile communication terminal of a user and including positional information of the mobile communication terminal;
an arrival time predicting unit that predicts an arrival time at which the user arrives at a retail store, based on the user-related information;
a generation time indication acquiring unit that acquires an indication of generation time during which a commodity that the user wishes to receive is generated at the retail store; and
a start time deciding unit that decides a generation start time for the commodity based on the arrival time and the generation time.

17. An information processing method to be executed by a computer, the information processing method comprising:
acquiring user-related information sent by a mobile communication terminal of a user and including positional information of the mobile communication terminal;
predicting an arrival time at which the user arrives at a retail store, based on the user-related information;
acquiring an indication of generation time during which a commodity that the user wishes to receive is generated at the retail store; and
deciding a generation start time for the commodity based on the arrival time and the generation time.

18. A commodity generating apparatus comprising:
an arrival time indication acquiring unit that acquires an indication of an arrival time at which a user arrives at a retail store, the arrival time being predicted based on user-related information sent by a mobile communication terminal of the user, and including positional information of the mobile communication terminal;
a generation time indication acquiring unit that acquires an indication of generation time during which a commodity that the user wishes to receive is generated; and
a commodity generating unit that starts generation of the commodity, and generates the commodity according to a generation start time for the commodity decided based on the arrival time and the generation time.

19. The commodity generating apparatus according to claim 18, comprising a customization content acquiring unit that acquires a content of customization of the commodity that is decided based on the user-related information, and recommended to the user, wherein
the commodity generating unit generates the commodity that is customized according to the content of customization.

20. The commodity generating apparatus according to claim 19, wherein
the generation time indication acquiring unit acquires an indication of generation time for the commodity that is required if the customization is performed about the commodity that the user wishes to receive, and
according to a generation start time for the commodity decided based on the arrival time, and the generation time for the commodity that is required if the customization is performed, the commodity generating unit starts generation of the commodity.

21. A non-transitory computer-readable storage medium having stored thereon a program for making a computer function as:
an arrival time indication acquiring unit that acquires an indication of an arrival time at which a user arrives at a retail store, the arrival time being predicted based on user-related information sent by a mobile communication terminal of the user, and including positional information of the mobile communication terminal;
a generation time indication acquiring unit that acquires an indication of generation time during which a commodity that the user wishes to receive is generated; and
a commodity generating unit that starts generation of the commodity, and generates the commodity according to a generation start time for the commodity decided based on the arrival time and the generation time.

22. A commodity generation method to be executed by a computer, the commodity generation method comprising:
acquiring an indication of an arrival time at which a user arrives at a retail store, the arrival time being predicted based on user-related information sent by a mobile communication terminal of the user, and including positional information of the mobile communication terminal;
acquiring an indication of generation time during which a commodity that the user wishes to receive is generated; and
starting generation of the commodity according to a generation start time for the commodity decided based on the arrival time and the generation time.
